(19) United States
(12) Patent Application Publication
(10) Pub. No.: US 2020/0402679 A1
(43) Pub. Date: Dec. 24, 2020

(54) Online Sensor and Process Monitoring System

(71) Applicant: ANALYSIS AND MEASUREMENT SERVICES CORPORATION, Knoxville, TN (US)

(72) Inventors: Alexander Hashem Hashemian, Knoxville, TN (US); Jacob Russell Houser, Knoxville, TN (US); Shawn Nathan Tyler, Knoxville, TN (US)

(21) Appl. No.: 16/911,076

(22) Filed: Jun. 24, 2020

Related U.S. Application Data
(60) Provisional application No. 62/865,694, filed on Jun. 24, 2019.

(51) Int. Cl. G21C 17/00

(52) U.S. Cl. CPC G21C 17/00

(57) ABSTRACT

An online monitoring system for industrial processes, such as nuclear power processes, including a data acquisition unit configured to sample output signals simultaneously from a plurality of process sensors, and a computing unit configured to record sampled output signals from the data acquisition unit and to cross-correlate the output signals from two or more of the process sensors to diagnose operation of the industrial process, identify loose parts and/or degradation of industrial plant equipment, enable virtual sensing, calculate sensor response time using the noise analysis technique, and to verify sensor calibration using the cross calibration method and/or empirical and/or physical modeling.

### CROSS-REFERENCE TO RELATED APPLICATIONS

This application claims the benefit of U.S. Provisional Application No. 62/865,694 filed on Jun. 24, 2019, the disclosure of which is incorporated by reference herein in its entirety.

### STATEMENT OF GOVERNMENT INTEREST

This invention was made with government support under contract number DE-SC0011859 awarded by the U.S. Department of Energy. The government has certain rights in the invention.

### BACKGROUND

The present invention pertains to an online monitoring system for verifying the static and dynamic performance of sensors in-situ, characterizing vital process parameters, identifying critical process anomalies, and trending the health of critical components within an industrial plant (e.g. a nuclear power plant).

Instrumentation and control (I&C) systems ensure the safe and efficient operation of an industrial plant. I&C sensors measure process parameters such as temperature, pressure, level, flow, and neutron flux among others and provide input to protection systems to shut down the plant in the event of an undesirable process transient.

For critical or safety-related functions, I&C sensor performance must be verified periodically. Accuracy and response time are two significant performance characteristics of any sensor. Accuracy relates to how well the sensor measurement agrees with the true value of the process parameter being measured. Response time relates to how quickly the sensor can detect a sudden change in the value of the process parameter being measured. To verify the accuracy of a sensor, it is calibrated. The procedure for calibration may vary by sensor depending on the operating principle and other constraints or sensor dissimilarities, but a general calibration process involves measuring a controlled physical parameter (e.g. temperature, pressure, etc.) at several points alongside a standard or reference sensor with lower measurement uncertainty. Data is collected from the sensor under test and the standard or reference sensor and used to generate a functional relationship between the output of the sensor under test and the physical parameter being measured. Sensor calibration may be performed in a laboratory, as it is typically done initially by the original equipment manufacturer. However, it is more desirable to verify sensor calibration in-situ after installation and/or at in-service process conditions. Similarly, for response time measurements, laboratory testing may be performed to determine the time it takes the sensor to respond to a sudden change in a physical parameter in the form of a step, ramp, or sinusoidal wave. For many sensors, response time is a strong function of process conditions such as temperature and flow. As a result, it is more desirable to verify sensor response time in-situ after installation and/or at in-service process conditions. When sensor performance is verified through testing while it is installed and in service in an operating plant, this activity is referred to as online testing.

In addition to I&C sensors that support plant operation and control, some industrial facilities including nuclear power plants may deploy a system for monitoring loose parts, such as nuts, bolts, and hand tools, within a process or coolant system. Loose parts within the system can damage critical plant equipment such as pumps resulting in costly maintenance or block the flow of coolant through a nuclear reactor core threatening the safety of the plant. Existing loose parts monitoring systems consist of externally mounted accelerometers, displacement transducers, strain gauges, and acoustic emission sensors to monitor vibration and sound within the process. Some systems may collect data from existing ex-core neutron detectors for monitoring reactor core barrel vibration, but subtle in-core phenomena and other process or sensor anomalies cannot be resolved by these existing monitoring systems using data from the ex-core instrumentation and externally mounted vibration sensors and acoustic listening devices. These systems cannot be used to verify the performance of sensors in-situ, trend the health of other plant components, or resolve in-core anomalies which requires input from in-core instrumentation (e.g. self-powered neutron detectors, core inlet and outlet thermocouples, etc.) among other I&C process sensors and advanced analysis techniques.

Known systems do not provide a comprehensive online monitoring system that samples and analyzes the output signals of a plurality of sensors while they are in-service in an industrial plant or similar facility for the purpose of in-situ sensor performance verification, characterization of vital process parameters, identification of critical process anomalies, and trending the health of plant components.

### BRIEF SUMMARY

According to one embodiment of the present invention, an online monitoring system for verifying sensor performance in-situ, characterizing vital process parameters, identifying process anomalies including detection of loose parts within a system, and trending the health of critical plant components is provided. The proposed system enables online and in-situ sensor testing in addition to continuous plant process and component condition monitoring through sensor data acquisition, analysis, and modeling and simulation.

The system samples the output signals of wired and/or wireless sensors installed in a process, mounted externally to plant equipment, or placed in the ambient environment of a plant. The system is capable of simultaneous data sampling on a plurality of sensors at a fast rate (up to thousands of times per second) to enable verification of the static (i.e. calibration) and dynamic (i.e. response time) performance of the sensors themselves, characterization of vital process parameters, identification of distinct or subtle process anomalies, and trending the health of critical plant components in support of improved operations and maintenance and aging management.

### BRIEF DESCRIPTION OF THE DRAWINGS

The above-mentioned features of the present general inventive concept will become more clearly understood from the following detailed description of the invention read together with the drawings in which:

FIG. 1 is a block diagram of a system configured according to an example embodiment of the present general inventive concept.

FIG. 2 is a simple diagram of an in-core instrumentation assembly containing several sensors that may be used in conjunction with example embodiments of the present general inventive concept.

FIG. 3 is a block diagram illustrating an example process of noise data acquisition.

FIG. 4 is a representation of the output signal of a sensor as a result of random process noise input to the sensor including a static component and a dynamic component.

FIG. 5 is an illustration of a theoretical Power Spectral Density (PSD) curve with break frequency according to an example embodiment of a noise analysis technique.

FIG. 6 is a graphical representation of the cross-correlation function using two data streams from two separate sensors installed in the same process.

### DETAILED DESCRIPTION

The online monitoring system according to the present invention is capable of in-situ verification of sensor performance, characterization of vital process parameters, identification of distinct or subtle process anomalies, and trending the health of critical plant components through sensor data acquisition, analysis, and modeling and simulation.

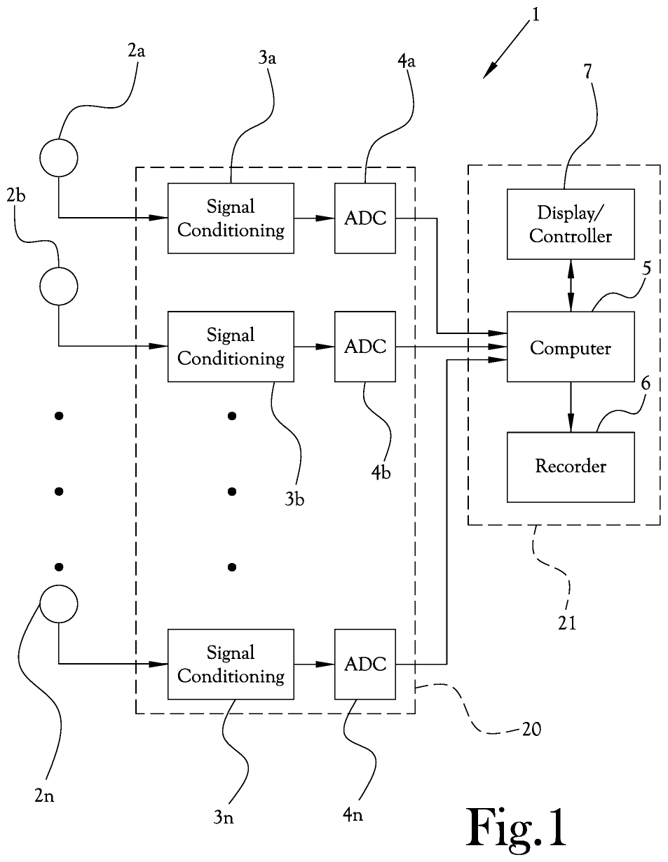

One embodiment of the proposed system is illustrated in FIG. 1. The system 1 detects sensor calibration drift, measures sensor response time, collects frequency spectrum signatures of the process and plant components, identifies blockages in a reactor core, instrument lines, or elsewhere in the process, and enables virtual sensing capabilities. The system 1 integrates an array of technologies into an apparatus and methods consisting of hardware that is used to collect sensor output signals and software routines and procedures to analyze the collected signals and determine the condition of sensors, processes, and components. Various embodiments of the invention include one or more of the following technologies: cross calibration and online monitoring of sensor calibration drift, noise analysis for sensor response time measurement, cross correlation of pairs of sensor signals for transit time flow measurement and detecting process anomalies, and modeling and simulation tools for trending the health of critical plant components.

FIG. 1 illustrates an embodiment of the proposed online monitoring system 1. A plurality of sensors 2a, 2b, 2n each provide a signal to a signal conditioning module 3a, 3b, 3n, to an analog-to-digital converter (ADC) 4a, 4b, 4n, and into a computer 5. The computer 5 can provide data to a recorder 6 and a display/controller 7. The signal conditioning module 3a, 3b, 3n can filter the sensor output signal, amplifies or attenuates the signal as appropriate, and performs other signal conditioning operations. The computer 5 executes software, or routines, for performing various functions. These routines can be discrete units of code or interrelated among themselves. One function of the software includes data qualification to determine whether the data indicates an outlier or bad data. If bad data is not indicated, then the data may be analyzed. The online monitoring system 1 uses several data analysis techniques including simple averaging, weighted averaging, cross correlation, noise analysis, empirical modeling, neural networks, and physical modeling. The recorder 6 can be coupled with the computer 5 to serve as a data storage and transmission device to store data locally and/or remotely to host system for trending and/or analysis. The data analysis results may be generated as plots, bar charts, tables, and/or reports which may be displayed and/or manipulated using the display/controller 7 which may be integrated directly with the computer 5 or exist as a standalone component of the system 1. The signal conditioning modules and ADC can be formed separately or together as a data acquisition unit 20. The computer 5, recorder 6, and display/controller 7 can be formed separately or together as a computing unit 21.

The sensors 2a, 2b, 2n, in one embodiment, may include in-core and ex-core neutron detectors, thermocouples, resistance temperature detectors (RTDs), flow sensors, pressure and/or differential pressure transmitters, and level sensors among others. Connection to sensors 2a, 2b, 2n may be made by accessing test points in which the output signal may be in the form of an electrical voltage or resistance or by tapping into sensor circuit loops which may be a standard 4-20 milliampere current loop. The signal conditioning modules 3a, 3b, 3n may provide isolation between the sensors 2a, 2b, 2n and the system 1. The analog-to-digital converters 4a, 4b, 4n convert the analog electrical signals to digital signals that may be input to the computer 5 for analysis.

In another embodiment of the system 1, inputs to the computer 5 may come directly from digital signals representing sensor values obtained from the plant or host computer which is monitoring the sensors 2a, 2b, 2n for other purposes, including operation and control of the plant.

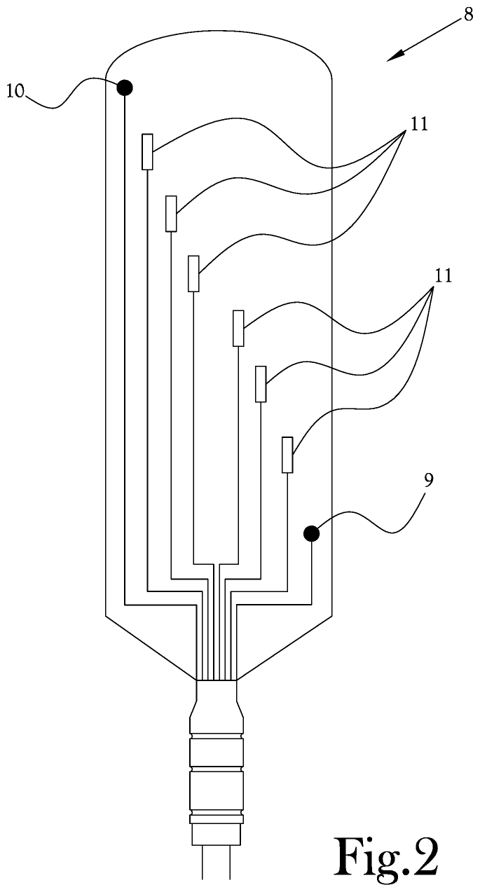

One embodiment of the proposed system 1 samples data at a fast rate from in-core instrumentation (e.g. self-powered neutron detectors, core inlet and outlet thermocouples, etc.) and other sensors. FIG. 2 illustrates a generic in-core instrumentation assembly 8 that consists of an inlet thermocouple 9, an outlet thermocouple 10, and six equally-spaced neutron detectors 11 that may be used in conjunction with the proposed system 1 for online monitoring applications. Several in-core instrumentation assemblies may be arranged throughout the core and installed vertically or horizontally through instrument tube channels within fuel assemblies. In-core instrumentation systems in nuclear power plants are typically used for monitoring temperature and/or neutron flux within the reactor core during normal operation and/or post-accident conditions. Embodiments of the present general inventive concept make use of in-core instrumentation to enable in-situ sensor performance verification and online monitoring functions such as reactor surveillance and diagnostics through high-speed multi-channel sensor data acquisition and analysis using the noise analysis technique, cross correlation, and cross calibration among others.

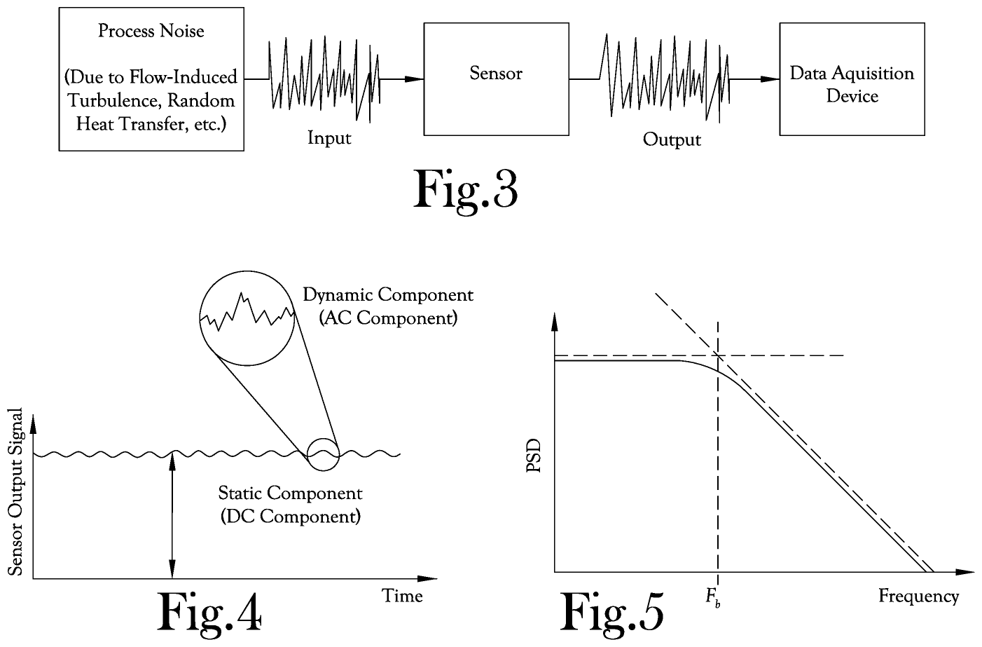

Several sensor output signals may be simultaneously sampled multiple times per second using a data acquisition device and analyzed automatically using the noise analysis technique. The noise analysis technique is a passive sensor response time test that is based on monitoring the natural fluctuations that exist at the output of the sensor while it is measuring a dynamic process. FIGS. 3 through 5 illustrate noise analysis. FIG. 3 is a block diagram illustrating the process of noise data acquisition. Noise from the process may result from flow-induced turbulence, random heat transfer, or other naturally occurring phenomena and is the dynamic input to the sensor. The resulting sensor output signal may be sampled at a fast rate and analyzed in the time and/or frequency domain. FIG. 4 is a representation of the output signal produced as a result of process noise input to the sensor including a static and dynamic component which contains fluctuations or process noise important to the determination of sensor response time or other important process and/or diagnostic information. The static component of the sensor output signal can be removed through the use of a high-pass filter or bias, leaving only the dynamic or noise component of the signal. The noise component is then amplified and passed through a low-pass filter to eliminate undesirable high-frequency electrical noise from the signal. Once the signal has been properly conditioned as described, the noise data may be analyzed in the frequency domain by generating a power spectral density (PSD) of the signal via a Fast Fourier Transform (FFT) algorithm and fitting a mathematical function to the PSD to yield parameters that are used to determine sensor response time or other information about the process. FIG. 5 is an illustration of a theoretical PSD curve.

For a simple first-order system, the break frequency identified from the PSD is all that is needed to determine sensor response time. The break frequency is the intersection of a line which forms the flat portion of the PSD curve with a line which follows the slope of the trailing portion. The simple representative PSD provided in FIG. 5 does not show any resonances or other process effects that may affect the response time determination or may be indicative of important diagnostic information about the sensor and/or the process. Autoregressive (AR) modeling, a time domain technique, may also be used in addition or in lieu of frequency domain analysis via FFT. Noise analysis is an online and in-situ test technique that can be applied to a variety of process sensors including neutron detectors, thermocouples, RTDs, flow sensors, pressure and/or differential pressure transmitters, and level sensors among others. Noise data can be collected on a single sensor, but this approach greatly limits the capability of the proposed system 1 to only sensor related testing functions.

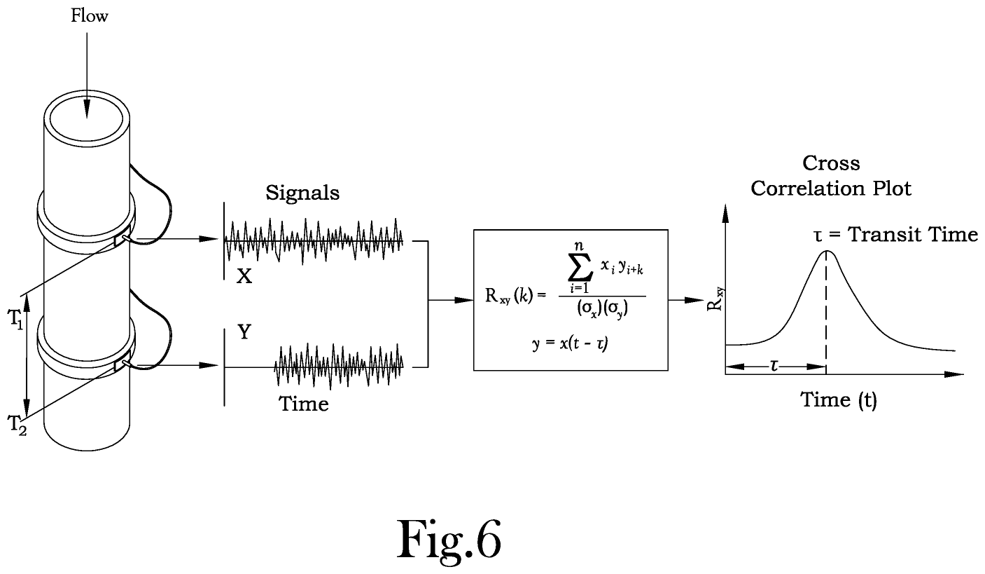

Noise data collected from two or more like or unlike sensors installed in a process enables the use of the cross correlation function to perform more robust sensor testing. More specifically, noise data collected from in-core sensors can be analyzed using a cross correlation function to calculate fluid transit time between upstream and downstream sensors as shown in FIG. 6 and thus determine local flow rates within the reactor core and/or average flow rate through the reactor core. This flow information obtained from a plurality of in-core sensor signal pairs can serve as a reference to verify the calibration of installed flow sensors within the plant and validate computational models for predictive maintenance. It should be noted that the calibration of the sensors used to calculate transit time has no effect on the use of cross correlation for flow measurement. However, sensor response time is an important consideration for cross correlation transit time flow measurements and must be known in order to properly compensate the sensor data. If the response times of the sensors are matched or if the sensors are sufficiently fast, then no compensation is required. The proposed online monitoring system 1 is capable of determining individual sensor response time values via automated noise analysis, cross correlating the response time compensated sensor data in real-time, generating additional process information such as transit time flow rates, and verifying the calibration of other installed sensors using cross correlated data according to the method described herein.

Noise data collected from ex-core sensors installed in the process can also be analyzed using a cross correlation function to calculate fluid transit time between upstream and downstream sensors as shown in FIG. 6 and determine flow rates through individual loops or sections of the plant. This flow information obtained from two or more sensors in a given ex-core loop can serve as a reference to verify the calibration of installed flow sensors within the plant and validate computational models for predictive maintenance applications.

For select applications such as integral small modular reactors (SMRs), online and in-situ sensor testing is greatly preferred to conventional hands-on and offline test methods which can be time consuming, costly, and difficult to accomplish given the unique constraints introduced by the integral reactor design. For most nuclear power plant applications, flow measurement may be accomplished using differential pressure based systems such as Venturi flow meters or orifice plates. Calibration of the differential pressure transmitters linked to these systems verifies the performance of the entire flow sensor system. However, in an integral SMR, there is no primary system loop piping. As a result, differential pressure based flow measurement systems cannot be used. Other flow sensor technologies such as ultrasonic flow meters may be suitable for integral SMR applications. Calibration verification of these types of sensors may be accomplished by removing them from their installation in the plant during shutdown and installing them on a test stand in a laboratory. However, verifying sensor calibration as installed at in-service conditions is ideal, as explained previously. The physical constraints and harsh conditions (e.g. high temperature, radiation) of an integral SMR may impact flow sensor redundancy and common-mode drift mechanisms. Therefore, the calibration verification method described herein may be the only viable online in-situ approach for flow sensors in an integral SMR.

In addition to cross correlation for calibration verification of flow sensors, the proposed online monitoring system 1 is capable of cross calibration of temperature, pressure, level, flow, and neutron flux sensors. Cross calibration is a test of the consistency of a group of like sensors that are measuring the same process variable. Drift is identified by comparing the outputs of several redundant sensors to distinguish between process drift and sensor calibration drift via simple averaging, weighted averaging, or other numerical analysis methods. For non-redundant sensors, cross correlation, empirical modeling using neural networks or other techniques, and/or physical modeling may be used to estimate the process and use this estimation as a reference for verifying the calibration of the sensors. This can be accomplished because there often exist complex physical relationships between one process parameter and another. The indirect measurement or estimation of a process parameter is sometimes referred to as virtual sensing. Virtual sensing is a valuable tool to monitor processes and aid in the detection of off-normal conditions. These tools and capabilities are incorporated into the proposed online monitoring system 1.

Noise analysis and cross correlation of sensors can also be used for critical reactor surveillance and diagnostics applications. For example, in-core transit time flow measurements can help plant operators determine if blockages are developing within the core before they may cause fuel elements to overheat or detect the presence of a loose part in the process more easily than an existing loose parts monitoring system. Ex-core neutron detectors can be cross correlated and analyzed with each other or in-core neutron detectors to provide the vibrational signature of the reactor vessel and its internals including the core barrel, thermal shield, and fuel assemblies among others. Furthermore, this data may be input to advanced modeling and simulation tools for improved reactor aging management studies that may reduce operations and maintenance costs and justify plant life extensions.

Noise analysis and cross correlation of sensors can also provide essential information regarding structural degradation and health of reactor components. For example, ex-core neutron detector signals can be cross correlated to quantitatively determine the magnitude of various vibrational modes of reactor components including the core barrel, thermal shields, and fuel assemblies as well as the operational characteristics of components such as the reactor coolant pumps. By trending these vibrational and operational characteristics, degradation of these components can be identified via deviations from normal operational values. Depending on the vibrational mode that has shifted it is sometimes even possible to determine whether the shift is caused by a structural degradation with the plant or a material degradation in an individual component. This information can provide early warning aging management information for operators that a given component may need to be refurbished, repaired, or replaced.

Cross correlation of diverse sensors can provide additional diagnostics for process anomalies. For example, ex-core neutron detectors, in-core neutron detectors, and core exit thermocouples can be used to identify periodic shifts in flow through a quadrant of the core. As flow rates in a core quadrant shift, the moderator temperature coefficient will change and be registered as a change in neutron noise seen by in-core and ex-core detectors. These flow rates will also impact the temperature readings of the core exit thermocouples in each quadrant. With the use of time series analysis and lag calculations from cross correlation, the origin of the anomaly can be identified.

In one embodiment of the present invention, each of the capabilities described herein are performed by an online monitoring system 1 comprising a multi-channel data acquisition and processing device, a computer 5 running one or more software routines, and a data storage and transmission device or recorder 6.

The multi-channel data acquisition and processing devices simultaneously samples output signals of installed process sensors 2a, 2b, 2n such as neutron detectors, thermocouples, resistance temperature detectors, flow sensors, pressure and/or differential pressure transmitters, and level sensors, used to control the plant as well as other wired and/or wireless sensors that may be used for equipment condition monitoring or other auxiliary plant functions. The data acquisition and processing device may sample the sensor output signals at a rate ranging from as low as less than one sample per second to as high as thousands of samples per second, as specified by the intended application or by the end user. The data acquisition and processing device may also include analog-to-digital converters 4a, 4b, 4n and signal conditioning modules 3a, 3b, 3n to convert raw analog signals into digital signals, to filter the sensor output signals, modify the signal amplitudes, or perform other operations.

The computer 5 executes software, or routines, for performing various functions. These routines can be discrete units of code or interrelated among themselves. The online monitoring system 1 uses several data analysis techniques including simple averaging, weighted averaging, cross correlation, noise analysis, cross calibration, empirical modeling, and physical modeling.

The data storage and transmission device or recorder 6 may be integrated with the system to store data locally and/or remotely to host system for trending and/or analysis.

As illustrated and described herein, example embodiments of the present general inventive concept for an online monitoring system can be effective when deployed in an industrial process with redundant sensors, such as a nuclear power plant, measuring a plurality of process parameters such as temperature, pressure, level, flow, and neutron flux among others. The proposed system may be integrated into the plant I&C architecture as a permanently installed and continuously operating system or retrofitted to an existing facility for continuous monitoring or periodic surveillance of plant sensors, processes, and components in support of improved operations and maintenance and aging management.

Example embodiments of the present general inventive concept can be achieved by an online monitoring system for nuclear reactors that is configured to collect and analyze signals from in-core instrumentation (e.g. neutron detectors, thermocouples, etc.) and other ex-core instruments to verify sensor performance in-situ, characterize vital process parameters, identify flow blockages in the reactor core or other process anomalies, measure reactor core barrel vibration, monitor for loose parts within the process, and trend the structural health of the reactor vessel, fuel assemblies, and internals over the life of the plant using computer modeling and simulation tools. In some embodiments, the system includes a multi-channel data acquisition and processing device to sample and condition the output signals of installed process sensors, such as neutron detectors, thermocouples, resistance temperature detectors, flow sensors, pressure and/or differential pressure transmitters, and level sensors, used to control the plant as well as other wired and/or wireless sensors that may be used for equipment condition monitoring or other auxiliary plant functions. A computing unit can be configured to analyze the data via signal cross correlation functions, noise analysis techniques, and other methods and output the results of the analysis automatically. A data storage and transmission device can be integrated with the computing unit to store data locally and/or remotely to host system for trending and/or analysis. The proposed online monitoring system is applicable to a variety of nuclear power plant designs including light water reactors, pressurized heavy water reactors, liquid metal-cooled reactors, gas-cooled reactors, molten salt reactors, small modular reactors, and microreactors among others. In some embodiments, the system can be configured for deployment in other power industries or non-static processes for in-situ sensor performance verification, predictive maintenance of plant equipment, and identification of process anomalies.

As described herein, the systems, apparatus, methods, processes, control systems, functions, and/or operations and software for implementing the example embodiments of the present general inventive concept, for example the data acquisition, processing, and computing units, may be wholly or partially implemented in the form of apparatus that includes processing elements and sets of executable instructions. The executable instructions may be part of one or more software applications and arranged into software architecture. In general, embodiments of the present general inventive concept may be implemented using a set of software instructions that are designed to be executed by a suitably programmed processing element (such as a CPU, GPU (graphics processing unit), microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The application modules may include any suitable computer executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. The computer-executable code or set of instructions may be stored in (or on) any suitable non-transitory computer-readable medium. In general, with regards to the embodiments described herein, a non-transitory computer-readable medium may include almost any structure, technology or method apart from a transitory waveform or similar medium.

As described, the computing unit and data acquisition and processing systems, apparatus, methods, processes, functions, software and/or operations for implementing the example embodiments of the present general inventive concept may be wholly or partially implemented in the form of a set of instructions executed by one or more programmed computer processors such as a central processing unit (CPU) or microprocessor. Such processors may be incorporated in the circuitry and components of an apparatus, server, client or other computing or data processing device operated by, or in communication with, other components of the system.

It should be understood that the modules or operations of the present general inventive concept as described and illustrated herein can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes, modules, or functions described in this application may be implemented as software code to be executed by a processor using any suitable computer language such as, for example, Java, JavaScript, C++, LabVIEW, or Perl using, for example, conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus, and may be present on or within different computational apparatuses within a system or network.

According to some example implementations, the term data acquisition and processing unit and/or the computing unit can be referred to as a control system, processing unit, or processor, as used herein, which may be a central processing unit (CPU), or conceptualized as a CPU (such as a virtual machine). In such example implementation, the CPU or a device in which the CPU is incorporated may be coupled, connected, and/or in communication with one or more peripheral devices such as, but not limited to, an electrochemical impedance spectroscopy (EIS), as well as one or more displays. In other example implementations, the processing unit or processor or computing unit may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology or method apart from a transitory waveform or similar medium.

Certain implementations of the disclosed technology are described herein with reference to block diagrams of systems, and/or to configurations, functions, processes, or methods. It will be understood that one or more of the configurations, methods, processes, and functions can be implemented by computer-executable program instructions. Note that in some embodiments, one or more of the configurations, methods, processes, systems, and functions may not necessarily need to be performed in a particular order, or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, systems, or methods described herein.

These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment.

1. An online monitoring system for an industrial process, comprising:
a data acquisition unit configured to sample output signals simultaneously from a plurality of process sensors; and
a computing unit configured to record sampled output signals from the data acquisition unit and/or digital signals representing sensor values from the plant or host computer which is monitoring the sensors for other purposes and to cross-correlate the output signals from two or more of the process sensors to diagnose operation of the industrial process, identify loose parts and/or degradation of industrial plant equipment, and/or enable virtual sensing.

2. The system of claim 1, wherein the computing unit is configured to record the output signals of process sensors to calculate response time of each sensor using the noise analysis technique or other methods.

3. The system of claim 1, wherein the computing unit is configured to record the output signals of process sensors to verify the calibration of each sensor using the cross calibration method and/or empirical and/or physical modeling.

4. The system of claim 1, wherein the data acquisition unit is configured to sample the output signals of process sensors at selected sampling frequencies, to convert raw analog sensor output signals to digital signals, to filter the output signals, to amplify or attenuate the output signals, and to linearize the output signals.

5. The system of claim 1, wherein the computing unit comprises executable software routines configured to perform one or more functions of simple or weighted averaging, cross correlation, noise analysis, cross calibration, empirical modeling, neural networking, and physical modeling based on the output signals.

6. The system of claim 1, wherein the computing unit includes a data storage and transmission device configured to store data corresponding to the output signals locally and/or remotely from the computing unit.
